(19) United States
(12) Patent Application Publication
(10) Pub. No.: US 2009/0164260 A1
(43) Pub. Date: Jun. 25, 2009

(54) Air taxi logistics system

(76) Inventor: Richard Kane, Lake Worth, FL (US)

Correspondence Address: Arthur M. Dula, 3106 Beauchamp St., Houston, TX, 77009, US

(21) Appl. No.: 12/004,973

(22) Filed: Dec. 24, 2007

(51) Int. Cl. G06Q 10/00; G06Q 20/00

(52) U.S. Cl. 705/5; 705/40; 705/8

(57) ABSTRACT

An air taxi system comprising means for dynamically optimizing travel by real time assessment of relevant factors between an origination street address and prospective origination airports, between prospective origination airports and prospective destination airports, and between prospective destination airports and a destination street address.

### FIELD OF INVENTION

The present invention pertains generally to the way air travel is booked and carrier logistics managed for the air taxi industry. More specifically, it pertains to an air taxi logistics system wherein the system automatically manages logistics by dynamically assigning elements such as passengers, air crews, and source and destination airports based on factors such as, but not limited to: proximity to street addresses of origin and destination, air and ground delays, weather, additional bookings, and a multitude of operational factors for the air carrier. In addition, ground transportation can be linked to this system, such that the system manages a passenger's ground transport from the origin street address to the aircraft and, after the flight, from the aircraft to the destination street address.

### BACKGROUND OF THE INVENTION

Passengers think of their local airport as the commercial terminal populated by large airliners, and about 600 of these airports serve the United States. The Federal Aviation Administration (FAA) designates these airports as class Bravo and class Charlie airspace. There are two additional types of airports, the small towered airport, class Delta, and the un-towered or un-controlled airports in class Echo or Golf airspace. Most travelers are not aware of the local facilities closest to the starting point of their trip (hereafter, origin street address), and even pilots are hard pressed to identify the closest airport to their destination street address. There are more than 10,000 of these smaller facilities.

The U.S. Department of Transportation's (DOT) Bureau of Transportation Statistics (BTS) tracks the on-time performance of domestic flights operated by large air carriers. In June 2006, fully 16% of these flights were late due to air carrier delays, including delays created by late arrivals. It is reasonable to expect that the delay percentage will jump substantially when higher security alert levels are in place. In addition, domestic security screening procedures require a three hour pre-flight check-in, adding six hours of round-trip airport wait time.

### Routing for Air Taxi Operations

To better understand the problems faced by the emerging class of Very Light Jets, consider turbo prop aircraft that closely emulate Very Light Jets' performance envelope. In particular, the TBM 700 has a maximum cruise of 300 kts, a service ceiling of 31,000 feet, and a range of 1500 NM. The TBM is slightly slower, flies 10,000 feet lower, and has greater range and payload than Very Light Jets.

According to FlightAware®, there were 5335 flights airborne at 6 PM CDT on Jul. 22, 2005. It is important to understand that both NASA's more aggressive model and the FAA's more conservative model show simultaneous flight numbers at least tripling over the next decade. What can make this possible is the use of the thousands of general aviation airports that will become part of the fabric of the Small Aircraft Transportation System, which models the current Very Light Jets as a first generation of aircraft. Understanding the routing and flight levels that will be available to this new breed of aircraft, and responding dynamically to changes in this routing will be critical to the efficient operations of the Air Taxi operator; perhaps even to the survival of the carrier and its passengers.

Both the TBM and the Very Light Jets are slower than the passenger jets flying at the same flight levels, and the difficulty of getting cleared even to Flight Level 310 (31,000 feet) in a TBM foreshadows the careful planning that will be required to safely operate the Very Light Jets at less than their most efficient projected cruising altitude. (Range calculations for the Very Light Jets are typically shown at the most efficient cruise altitude of 41,000 feet and will not reflect real world operations). The range and payload of the emerging Very Light Jets will be limiting factors, and must be carefully managed—a problem well suited to automation and data mining.

It is known in the art to operate an airline where pilots fly pre-set routes. It is also known to use software to keep track of available seats on a scheduled flight and assign available seats to particular passengers. However, in order to fully realize the promise of Air Taxi and make the most use of local airports, a new class of real time software capable of complex optimizations is required. The present inventor is not aware of any prior art system that seeks to dynamically optimize cost, safety, and total travel time by considering factors such as: distance and traffic conditions between each passenger's origination street address and prospective source airports; distance and traffic conditions between the destination airport and the destination street address; terrain, flight envelope, and difficulty of takeoff and landing at prospective airports under various conditions; pilots' flight experience at prospective source and destination airports; flight capabilities of available aircraft, including Very Light Jets; air traffic conditions; and weather conditions en route and at prospective airports.

### SUMMARY

An air travel optimization system comprising a program that dynamically selects source and destination airports by performing real time assessment of travel factors between a traveler's origination street address and prospective source airports and between prospective destination airports and said traveler's destination street address.

### DESCRIPTION OF THE FIGURES

The present invention is illustrated by way of example, and not by way of limitation, in the figures of the accompanying drawings in which:

FIG. 1 shows a flow chart of the major steps and factors considered for determining air taxi logistics, in accordance with an embodiment of the invention.

FIG. 2 shows a table of the most common routes assigned between AIR PORT A and AIR PORT B indexed by altitude, in accordance with an embodiment of the invention.

FIG. 3 shows an automatic assignment algorithm based on fuel costs, in accordance with an embodiment of the invention.

### DETAILED DESCRIPTION

In the following description, for the purposes of explanation, numerous specific details are set forth in order to provide a thorough understanding of the present invention. It will be apparent, however, that the present invention may be practiced without these specific details.

Private air taxi can provide substantial per trip time savings. In accordance with an embodiment of the invention, minimized ground travel to the closer airport, streamlined security and check in procedures, flawless direct luggage transfer, and reduced aircraft taxi and clearance times will save hours over airline travel, and these savings will be calculated and displayed versus airliner schedules. Time savings will be most dramatic when a private air taxi system can eliminate the need for interconnection on regional flights, or when the system's schedule flexibility allows a day trip rather than an overnight stay.

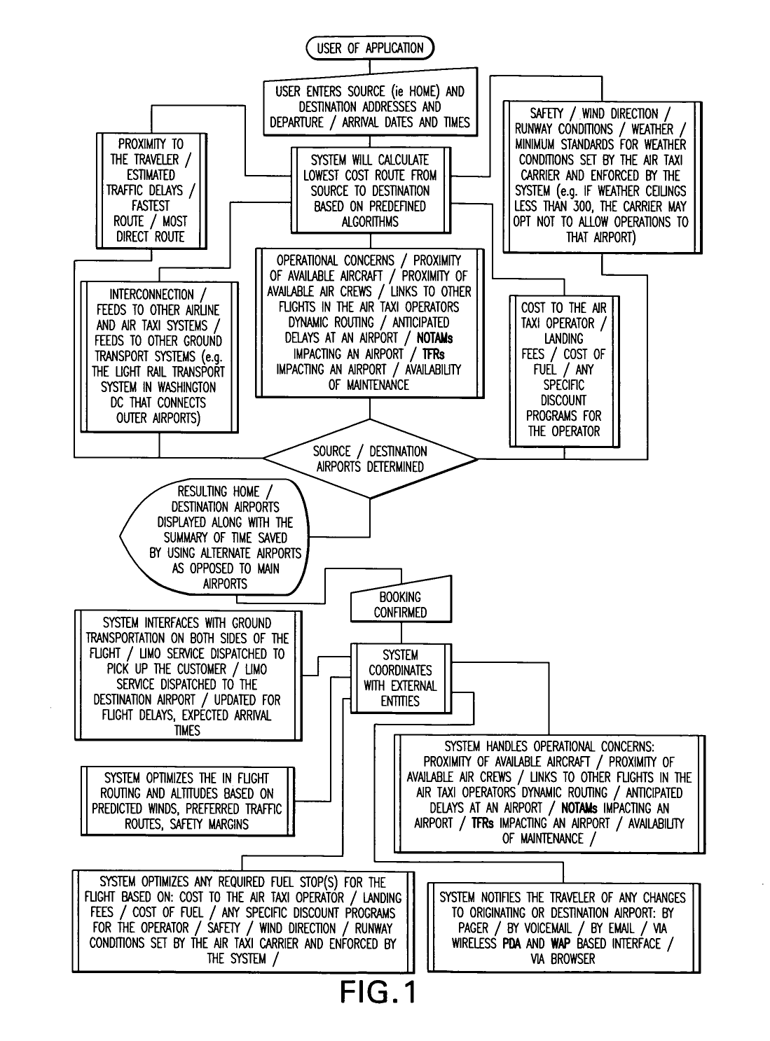

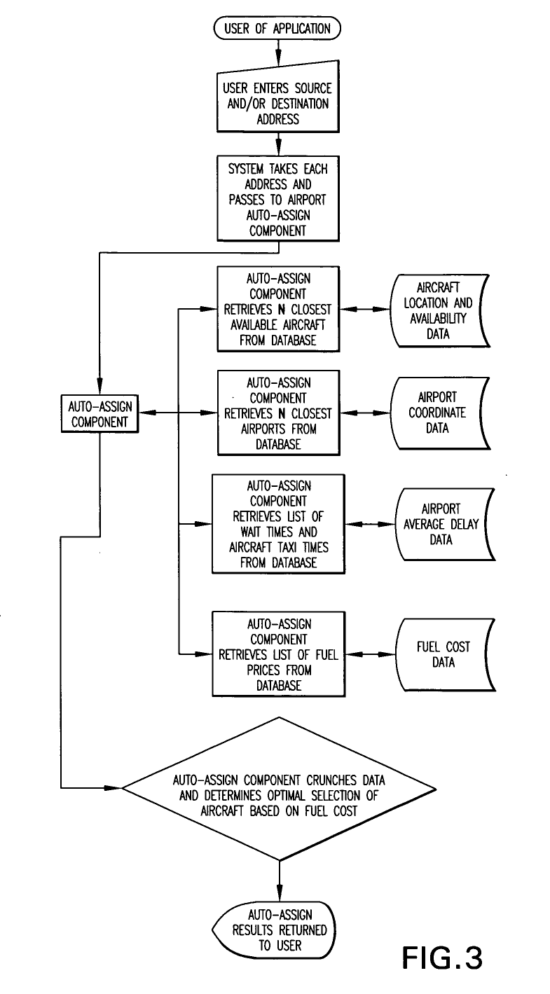

In accordance with an embodiment of the invention, many airline travelers who would otherwise fly from one of the approximately 600 major airports to another major airport can instead use thousands of smaller airports nearer their origin street addresses and destination street addresses. As shown in FIGS. 1 and 3, an embodiment could use an air travel logistics system that has a decision logic comprising means for selecting at least one optimized flight route based on travelers' origin/destination address data pairs and said system could function dynamically and make choices based on changing conditions and requests.

In accordance with an embodiment of the invention, a system could include decision logic that evaluates ground travel criteria such as:
Prospective airports' proximity to the traveler's origin and destination street addresses
Estimated traffic delays
Fastest route
Most direct route
Available mass transit

In accordance with an embodiment of the invention, a system could interface with ground transportation on both sides of the flight such as:
Limo service dispatched to pick up the customer
Limo service dispatched to the destination airport and updated for flight delays and expected arrival times

In accordance with an embodiment of the invention, a system could evaluate operational criteria such as:
Available aircraft's proximity to a prospective source airport
Available air crews' proximity to a prospective source airport
Links to other flights in the air taxi operator's dynamic routing system Anticipated delays at a prospective airport
Notices to Airmen (NOTAMs) impacting a prospective airport
Temporary Flight Restrictions (TFRs) impacting a prospective airport
Availability of aircraft maintenance

In accordance with an embodiment of the invention, a system could include decision logic that evaluates safety criteria such as:
Wind direction
Runway conditions
Weather
Minimum standards for weather conditions set by the air taxi carrier and enforced by the system (e.g. if weather ceilings are less than 300′, the carrier may opt not to allow operations to that airport)
Whether passengers or crew are listed on a terrorist watch list

In accordance with an embodiment of the invention, a system could optimize the in-flight routing and altitudes based on factors such as:
Predicted winds
Preferred traffic routes
Safety margins

In accordance with an embodiment of the invention, a system could plan fuel ops to minimize cost to the air taxi operator based on:
Landing Fees
Fuel cost
Any specific discount programs for the operator

According to a further feature in accordance with an embodiment of the invention, a system could evaluate interconnection options such as:
Feeds to other airline and air taxi systems
Feeds to other ground transport systems (e.g. a light rail transport system)

According to a further feature in accordance with an embodiment of the invention, a system could automatically send reminders or notify travelers of any change in schedule or route:
By Pager
By Voicemail
By Email
Via wireless PDA and WAP based interface
Via browser

In accordance with an embodiment of the invention, a method may comprise the following steps, as shown by way of example in FIG. 1:
(a) A traveler enters origin address, destination address, and time data.
(b) The system begins to run an algorithm to optimize route for factor(s) such as cost, time, and safety.
(c) The system considers:
   a. Origin and destination addresses' proximity to prospective airports;
   b. Interconnection/Feeds to other airline and air taxi systems and other ground transportation transport systems
   c. Operational factors such as:
      i. Proximity of available air crews
      ii. Dynamic routing for links to other flights
      iii. Airport delays
      iv. NOTAMs impacting an airport
      v. TFRs impacting an airport
      vi. Maintenance availability
   d. Safety factors such as:
      i. Wind direction
      ii. Runway conditions
      iii. Weather and air taxi carrier's minimum standards
   e. Air Taxi operator cost factors such as:
      i. Landing fees
      ii. Fuel costs
      iii. Discount programs
(d) The system determines source and destination airports;
(e) The system displays source and destination airports and schedule along with a Summary of Time Saved by using the system to select alternate airports rather than use main airports.
(f) Booking is confirmed.
(g) The system coordinates with external entities as follows:
   a. The system arranges ground transportation (such as a limo service) before and after the flight and keeps the ground transportation service updated for flight delays and expected arrival times.
   b. The system optimizes the in flight routing and altitudes based on predicted winds, preferred traffic routes, and safety margins.
   c. The system optimizes any required fuel stop(s) for the flight based on:
      i. Air taxi operator cost
      ii. Landing fees
      iii. Fuel cost
      iv. Discount programs
      v. Safety
      vi. Wind direction
      vii. Runway conditions
      viii. Weather and the air taxi carrier's minimum weather condition standards enforced by the system
   d. System notifies the traveler of any changes to origination or destination airport by pager, voicemail, email, wireless PDA and WAP based interface, or browser.
   e. The system handles operational concerns such as:
      i. Proximity of available air crews
      ii. Dynamic routing for links to other flights
      iii. Airport delays
      iv. NOTAMs impacting an airport
      v. TFRs impacting an airport
      vi. Maintenance availability

### The Air Taxi Optimization Problem

The successful air taxi operator will need a real time system that, in accordance with an embodiment of the invention, can minimize Non Revenue Flight Miles (NRFM), Non Revenue Flight Operations (NRFO), Landing Fees, Fuel Surcharges, and Flight Delays while optimizing the passenger experience. As illustrated in FIG. 3, an algorithm in accordance with an embodiment of the invention could receive origin and destination address input from a user, and then automatically evaluate relevant criteria to determine optimal aircraft selection and return results to the user.

There is a need for a system that can, in accordance with an embodiment of the invention, dynamically assign aircraft and flight crews based on an ever changing landscape, including new customer bookings, unusual airport delays, maintenance events, fuel cost updates, ATC routing changes, aircraft weight and balance, air crew experience and familiarity with particular airports, air crew fatigue, and weather systems.

No airline in existence today has faced a dynamic routing problem of this scale: potentially thousands of jets with crew assignments, manifests and routing assigned in response to passenger bookings and changing conditions. The present inventor believes that the science of telecom traffic engineering represents the closest real world model to this problem: the real time routing and optimization programming employed to manage the nation's largest telecom networks holds a key to capacity planning, route optimization, and dynamic re-routing/route-around for optimal traffic flow.

Telecom network traffic engineering systems provide least cost routing support for billions of transactions per month. These systems demonstrate the scalability and fault tolerance required to manage large scale air carrier class operations based on fleets of Very Light Jets. The telecom numbers dwarf the calculations required to optimize air taxi operations; however, as the number of passenger bookings, Very Light Jets in service, and airline crews grows, the optimization problem does get more calculation intensive (grows logarithmically), while the responsiveness of real time dispatch must never be compromised. The best approach to managing this is the high speed parallel processing that has been deployed in the telecom space.

### Driving Safety for Very Light Jets in the National Air Space System

The primary safety differences between Air Taxi Operations and Carrier Operations involve the experience of airline crews with a set of familiar route destinations, and the oversight of dedicated flight planning departments.

Safety in the Air Taxi paradigm will involve the prioritization of selection of airline crews that have familiarity with the airports being served and the alternate airports on a given flight. The importance of this safety initiative is compounded by the greater number of airports available to the Air Taxi system and the lack of standardization of approaches, precision approaches, lighting systems, and runway environments at these airports. It is highly likely that an aircrew will be approaching an unfamiliar airport with sub standard approach lighting, safety overruns and terrain clearance, if familiarity with the destination airport is not factored in during the crew assignment process.

Weather issues further compound the need for sophisticated flight planning, and familiarity with the source, destination and en-route environments. Low ceilings, turbulence and terrain combine with the lack of precision approaches to create a much higher risk profile. In accordance with an embodiment of the invention, to enhance safety the system should prioritize air crews with prior experience at an air field over those who do not. Evaluation should be based on how many times and how recently a pilot has used an airfield. The system could even enforce a rule that at least one of the pilots must have already flown into an airfield before a plane can be dispatched. Experience at alternate airports could also be considered.

A method for an automated review of flight plans with regard to risk factors will be crucial to the safe operation of Very Light Jets, to aid in Critical Decision Making. In accordance with an embodiment of the invention, each flight can be scored based on flight crew (experience, familiarity, and crew rest), weather (en route, source and destination) and destination (precision approach, circling approach) metrics, and high risk operations can be flagged for review by the Air Taxi Operator. The review can include checking for sufficient fuel and NBAA IFR reserves, proper weight and balance, creation of seating charts, and any required fuel loading changes based on customers with over gross weight profiles (luggage or passengers).

Finally, in accordance with an embodiment of the invention, an automated security check against homeland security watch lists can be conducted on each crew member and passenger prior to each flight. Optional criminal database checks may also be incorporated. Currently this is not implemented in Air Taxi operations, which represent a growing risk factor for terrorism.

### Driving Efficiency for Very Light Jets in the National Air Space System

Route optimization depends on knowledge of the routes most likely to be assign between airport city pairs. The use of direct flight miles is insufficient for route optimization purposes.

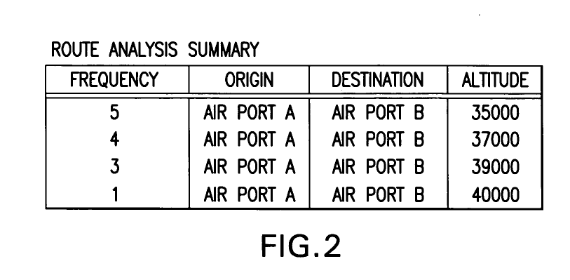

To illustrate by way of example how factors may be evaluated by a system that is an embodiment of the present invention, FIG. 2 shows a table of the most common routes assigned between AIR PORT A and AIR PORT B indexed by altitude. Note the ability to fly more direct at 40,000 feet than at lower altitudes. Most passenger jets cannot climb directly to the 41,000 foot service ceiling of the Very Light Jets; conversely a Very Light Jet can make this climb without intermediate stops to burn fuel. Understanding and modeling these performance characteristics can drive savings in fuel and time. Conversely the typical Very Light Jet will not be able to fly directly from AIR PORT A to AIR PORT B with sufficient fuel reserves, and the time required to climb to altitude must be set against the need for a fuel stop and the second climb/descent.

In the foregoing specification, embodiments of the invention have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

I claim:

1. A method of optimizing air taxi travel between an origination address and a destination address comprising:
entering said origination address, said destination address, and travel time data,
evaluating relevant factors according to an algorithm, and
determining an optimized travel itinerary based on relevant factors.

2. The method of claim 1 wherein said relevant factors comprise cost factors.

3. The method of claim 2 wherein said cost factors comprise landing fees, fuel costs, and operator discount programs.

4. The method of claim 2 wherein said cost factors comprise ground transportation costs.

5. The method of claim 2 wherein costs factors comprise lodging costs.

6. The method of claim 2 wherein costs factors comprise demand pricing, whereby said algorithm chooses from among a larger number of origination airports or destination airports to enable greater cost savings.

7. The method of claim 2 wherein costs factors comprise demand pricing, whereby said algorithm schedules a flight during a larger time window to enable greater cost savings.

8. The method of claim 2 wherein costs factors comprise dynamically rerouting a passenger to another airport to avoid repositioning an aircraft.

9. The method of claim 1 wherein said relevant factors comprise safety factors.

10. The method of claim 9 wherein said safety factors comprise:
wind direction,
runway conditions,
weather,
aircraft weight and balance,
air crew experience,
air crew familiarity with prospective airports and alternate airports, and
air crew fatigue.

11. The method of claim 10 further comprising the step of enforcing minimum safety standards.

12. The method of claim 11 wherein enforcing minimum safety standards comprises the steps of:
i. scoring each flight based on flight crew metrics, weather metrics, passenger metrics, and destination metrics, and
ii. flagging high risk operations for review.

13. The method of claim 12 wherein said flight crew metrics comprise:
i. crew experience,
ii. crew familiarity with prospective airports
iii. crew familiarity with alternate airports,
iv. crew fatigue, and
v. validity of crew medical certifications and pilot qualifications.

14. The method of claim 12 wherein said weather metrics comprise:
i. origination airport weather conditions,
ii. en route weather conditions, and
iii. destination airport weather conditions.

15. The method of claim 12 wherein said passenger metrics comprise a watch list.

16. The method of claim 12 wherein said destination metrics comprise:
i. precision approach and
ii. circling approach.

17. The method of claim 12 comprising the additional step of reviewing flagged high risk operations.

18. The method of claim 17 wherein said reviewing flagged high risk operations comprises enforcing flight rest requirements, ensuring that at least one member of said flight crew has already flown into a destination airport, checking for sufficient fuel and NBAA IFR reserves, checking for proper weight and balance, creating seating charts, and updating required fuel loading.

19. The method of claim 1 wherein said relevant factors comprise ground travel factors.

20. The method of claim 19 wherein said ground travel factors comprise:
i. distance between said origination address and prospective origination airports,
ii. available ground transportation between origination address and prospective origination airports,
iii. distance between prospective destination airports and said destination address, and
iv. available ground transportation between prospective destination airports and said destination address.

21. The method of claim 20 wherein said ground travel factors further comprise:
i. traffic conditions between said origination address and prospective origination airports, and
ii. traffic conditions between prospective destination airports and said destination address.

22. The method of claim 21 wherein said ground travel factors further comprise:
i. fastest route between said origination address and prospective origination airports, and
ii. fastest route between prospective destination airports and said destination address.

23. The method of claim 1 wherein said relevant factors comprise interconnection factors.

24. The method of claim 23 wherein said interconnection factors comprise opportunities to connect with other airlines, air taxi systems, or ground transportation systems.

25. The method of claim 1 wherein said relevant factors comprise operational factors.

26. The method of claim 25 wherein said operational factors comprise:
i. available aircraft's proximity to prospective origination airports,
ii. available air crews' proximity to prospective origination airports,
iii. links to other flights in the air taxi operator's dynamic routing system,
iv. anticipated airport delays,
v. Notices to Airmen impacting a prospective airport,
vi. Temporary Flight Restrictions impacting a prospective airport, and
vii. aircraft maintenance availability.

27. The method of claim 26 wherein said available aircraft comprise very light jets.

28. The method of claim 26 wherein said available aircraft comprise aircraft having a sufficient number of hours and cycles until the next mandatory service is due.

29. The method of claim 1 wherein said determining optimized travel itinerary comprises selecting an origination airport and a destination airport.

30. The method of claim 29 wherein said origination airport and said destination airport comprise small airports.

31. The method of claim 1 wherein said determining optimized travel itinerary comprises selecting ground transportation.

32. The method of claim 1 wherein said optimized travel itinerary provides for lowest cost travel to destination address.

33. The method of claim 32 comprising the additional step of displaying calculated cost savings prior to booking.

34. The method of claim 33 wherein said cost savings comprise ground transportation cost savings and lodging cost savings.

35. The method of claim 1 wherein said optimized travel itinerary provides for lowest round trip cost.

36. The method of claim 35 comprising the additional step of displaying calculated cost savings prior to booking.

37. The method of claim 36 wherein said cost savings comprise ground transportation cost savings and lodging cost savings.

38. The method of claim 1 wherein said optimized travel itinerary provides for shortest travel time to said destination address.

39. The method of claim 38 comprising the additional step of displaying calculated time savings prior to booking.

40. The method of claim 1 wherein said optimized travel itinerary provides for shortest round trip travel time.

41. The method of claim 40 comprising the additional step of displaying calculated time savings prior to booking.

42. The method of claim 1 wherein said optimized travel itinerary provides for optimum safety.

43. The method of claim 1 comprising the further step of communicating said optimized travel itinerary.

44. The method of claim 1 comprising the further step of confirming booking.

45. The method of claim 1 comprising the further step of coordinating with external entities.

46. The method of claim 45 wherein said coordinating with external entities comprises:
i. interfacing with a ground transportation provider,
ii. optimizing in-flight routing and altitudes,
iii. optimizing fuel stops based on cost factors and safety factors,
iv. optimizing operational factors, and
v. notifying a passengers of any changes to said optimized travel itinerary

47. The method of claim 1 comprising the further step of re-optimizing aircraft positioning after receiving each flight request.

48. The method of claim 1 comprising the further step of accessing a real time database and using real time data for said evaluating relevant factors and said determining an optimized itinerary.

49. The method of claim 48 comprising the further step of updating said real time database.

50. The method of claim 48 wherein said real time data comprises:
i. aircraft usage,
ii. maintenance schedule,
iii. safety factors,
iv. operational factors,
v. cost factors,
vi. ground travel factors,
vii. interconnection factors,
viii. flight crew metrics,
ix. weather metrics,
x. passenger metrics, and
xi. destination metrics.

51. The method of claim 1 comprising the further step of minimizing non-revenue flight miles by optimizing ground transport routes and times associated with overlapping flight requests.

52. The method of claim 1 comprising the further step of combining overlapping requests.

53. The method of claim 1 comprising the further step of processing billing and credit card payment in real time.

54. An air taxi system comprising means for dynamically optimizing travel by real time assessment of relevant factors between an origination street address and prospective origination airports, between prospective origination airports and prospective destination airports, and between prospective destination airports and a destination street address.

55. The air taxi system of claim 54 wherein said relevant factors comprise:
i. safety factors,
ii. operational factors,
iii. cost factors,
iv. ground travel factors, and
v. interconnection factors.

56. The air taxi system of claim 54 further comprising means for optimization, logistics management, real time demand pricing, and real time booking and confirmation.

57. The air taxi system of claim 54 further comprising means for sharing available capacity, empty flights, reservations, and customer information among transportation providers.

58. The air taxi system of claim 54 wherein said system comprises XML based architecture.

59. The air taxi system of claim 54 wherein said system is scalable.

60. The air taxi system of claim 54 wherein said system is transaction based.

61. The air taxi system of claim 54 wherein said system comprises means for browsing value priced existing flights.

62. The air taxi system of claim 54 wherein said system comprises means for booking empty aircraft or available seats at reduced pricing.

63. The air taxi system of claim 54 wherein said system comprises means for automatically matching flights to existing flight requests.

64. The air taxi system of claim 54 wherein said system comprises means for automatically comparing flight requests to existing flights with available capacity.

65. The air taxi system of claim 54 wherein said system comprises means for dynamically repositioning passengers by booking ground transportation.

66. The air taxi system of claim 54 wherein said system comprises means for assigning a passenger to a confirmed flight with an available seat.

67. A method of optimizing travel between an origination address and a destination address comprising:
assessing relevant factors between a traveler's origination street address and prospective source airports,
assessing relevant factors between prospective source airports and between prospective destination airports, and
assessing relevant factors between prospective destination airports and said destination street address.

68. An air taxi system comprising means for dynamically assigning aircraft and flight crews by monitoring and evaluating relevant factors according to an algorithm.

69. The air taxi system of claim 68 wherein said relevant factors comprise:
i. safety factors,
ii. operational factors,
iii. cost factors,
iv. ground travel factors, and
v. interconnection factors.
